(19) United States
(12) Patent Application Publication
(10) Pub. No.: US 2026/0202901 A1
(43) Pub. Date: Jul. 16, 2026

(54) POWER CONTROL APPARATUS, LOAD VARIATION AMOUNT CALCULATION METHOD, AND PROGRAM

(71) Applicant: NTT, Inc., Tokyo (JP)

(72) Inventors: Motoki SUWABE, Tokyo (JP); Hiroya MINAMI, Tokyo (JP); Masaki KOZAI, Tokyo (JP)

(73) Assignee: NTT, Inc., Tokyo (JP)

(21) Appl. No.: 19/136,212

(22) PCT Filed: Dec. 13, 2022
(86) PCT No.: PCT/JP2022/045934

§ 371 Date: Jun. 5, 2025

(51) Int. Cl. G06F 1/3296; G06F 1/30

(52) U.S. Cl. CPC G06F 1/3296; G06F 1/305

(57) ABSTRACT

A power control apparatus for use in a system including one or more racks each equipped with one or more servers includes an acquisition unit configured to acquire power consumption and a total load value of a target rack, and a calculation unit configured to calculate a load variation amount, which corresponds to an amount of power consumption control for the target rack, based on the power consumption, the total load value, and a power consumption characteristic of the target rack.

### DESCRIPTION

### Technical Field

The present invention relates to technology for controlling the power consumption of a device.

### Background Art

A large number of servers operate at a plurality of bases (for example, data centers) to provide various services. A large number of servers consume a large amount of power.

On the other hand, as power generation with large variations such as renewable energy power generation increases, it is important to adjust the supply and demand of power in order to keep a power system stable.

For example, a consumer (such as a data center) that cooperates for adjustment of supply and demand adjusts the power consumption of servers, air conditioners, and the like in response to a request from a power company to increase or decrease power consumption.

In relation to the adjustment of power consumption, NPL 1 discloses a method of reducing power consumption by using a linear relationship between a CPU load and power consumption.

### CITATION LIST

### Non-Patent Literature

NPL 1: Takatsugu Oya, Hiroshi Sasaki, Masaaki Kondo, Hiroshi Nakamura. 2008. “Power-Performance Modeling for Heterogeneous Cluster-Based Web Servers.” IPSJ Research Report Computer Architecture (ARC), 2008 (75(2008-ARC-179)), 157-162 (2008-07-29)

### SUMMARY OF INVENTION

### Technical Problem

It is assumed that power consumption is controlled in units of racks in actual operational environments such as data centers. However, since a plurality of servers that process different services and their associated NW equipment are mounted on a rack, the relationship between CPU load and power consumption in units of racks is not linear. For this reason, the technology disclosed in NPL 1 makes it difficult to appropriately control (adjust) power consumption.

The present invention has been made in view of the above circumstances, and an object thereof is to provide technology for making it possible to appropriately control the power consumption of a rack on which one or more servers are mounted.

### Solution to Problem

According to the disclosed technology, provided is a power control apparatus for use in a system including one or more racks each equipped with one or more servers, the power control apparatus including:
an acquisition unit configured to acquire power consumption and a total load value of a target rack; and
a calculation unit configured to calculate a load variation amount, which corresponds to an amount of power consumption control for the target rack, based on the power consumption, the total load value, and a power consumption characteristic of the target rack.

### Advantageous Effects of Invention

The disclosed technology makes it possible to appropriately control the power consumption of a rack on which one or more servers are mounted.

### BRIEF DESCRIPTION OF DRAWINGS

FIG. 1 is a diagram showing an example of an overall configuration of a system according to an embodiment of the present invention.

FIG. 2 is a diagram showing an example of the relationship between total CPU load and power consumption in units of racks.

FIG. 3 is a flowchart showing a processing operation of a power control apparatus 100.

FIG. 4 is a diagram showing processing for calculating a CPU load variation amount of a target rack.

FIG. 5 is a diagram showing a configuration example of the power control apparatus 100.

FIG. 6 is a diagram showing an example of a hardware configuration of the device.

### DESCRIPTION OF EMBODIMENTS

Hereinafter, an embodiment of the present invention (the present embodiment) will be described with reference to the drawings. The embodiment to be described below is only one example, and an embodiment to which the present invention is applied is not limited to the following embodiment.

### Configuration Example of System, Overview of Operation

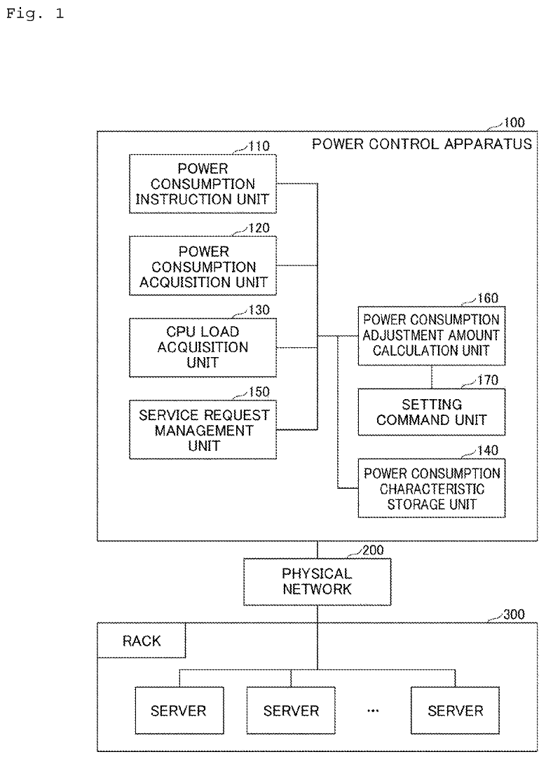

FIG. 1 shows an example of an overall configuration of a system according to the present embodiment. As shown in FIG. 1, a base 300 including a server group (or a single server) is connected to a power control apparatus 100 via a physical network 200. In reality, there are a plurality of bases, but only one base 300 is shown in FIG. 1.

Commercial power is supplied to the base 300 from, for example, a power company. Software that operates on each server at the base 300 is not limited to specific software, and, for example, a virtual machine (VM) may operate on these servers. Between servers on which VMs operate, it is possible to adjust the CPU load by moving the VMs.

The plurality of servers at the base 300 are mounted on one or a plurality of racks. Here, it is assumed that the plurality of servers at the base 300 are mounted on a plurality of racks.

As described above, in actual operational environments such as data centers, a plurality of servers that process different services and their associated NW equipment are mounted on individual racks. Furthermore, when power consumption is controlled in units of racks, there is a nonlinear relationship between the total CPU load of the servers and the power consumption of the racks.

Consequently, the present embodiment focuses on the relationship between the total CPU load in units of racks and power consumption, instead of focusing on power consumption of each server, and uses this nonlinear relationship as a characteristic. By controlling CPU load in units of racks, the power control apparatus 100 can control the power consumption at the base 300 (which may be referred to as a “system”) to target power consumption in response to an increase/decrease request for the power consumption for the base 300.

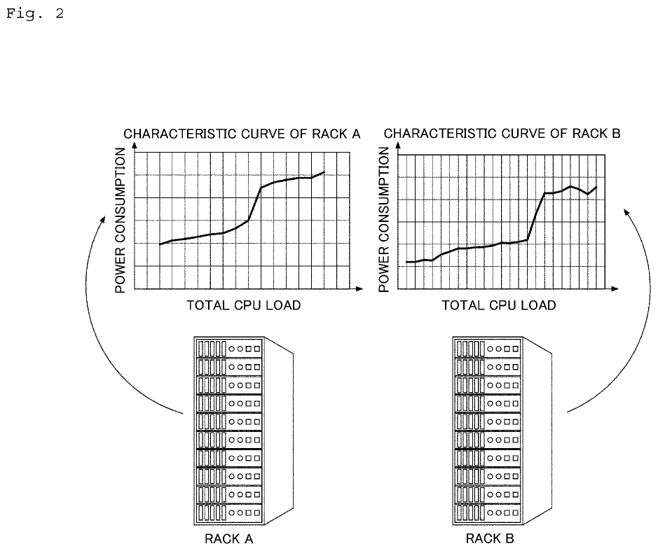

FIG. 2 is a diagram showing that the relationship between total CPU load (specifically, the total CPU utilization rate of the servers) and power consumption in units of racks is nonlinear. As shown in FIG. 2, in general, the relationship between total CPU load and power consumption shows varying characteristics per rack.

In the present embodiment, a characteristic curve of the relationship between total CPU load and power consumption as shown in FIG. 2 is acquired by measuring, for each rack, the total CPU load of all servers mounted on the rack and the power consumption of the rack. Hereinafter, the “characteristic curve of the relationship between total CPU load and power consumption” may be referred to as a “characteristic curve,” a “power consumption characteristic,” or the like.

Each rack's characteristic curve is stored in advance in a power consumption characteristic storage unit 140 shown in FIG. 1. When performing control in response to a request to increase or decrease power, the power control apparatus 100 adjusts the CPU load of servers mounted on a rack to obtain target power consumption in units of racks based on respective characteristic curves.

This control method makes it possible to stably control power consumption even when the accuracy of control of CPU load is not higher than that of power consumption control based on the linearity of each individual server based on the related art.

Regarding the total CPU load on each rack, for example, assuming that a certain rack includes a server 1, a server 2, and a server 3 and that the CPU utilization rate of the server 1 is 30%, the CPU load rate of the server 2 is 50%, and the CPU load rate of the server 3 is 40%, the total CPU load of the rack is 30%+50%+40%=120%.

In addition, regarding power consumption of each rack, a certain rack's power consumption can be measured within that rack. That is, it is not necessary to measure individual power consumption of each of a plurality of pieces of equipment (including servers) mounted on the rack and calculate the total. Instead, it is possible to measure power consumed by all the equipment mounted on the rack, within the rack.

### Description of Device Configuration

As shown in FIG. 1, the power control apparatus 100 in the present embodiment includes a power consumption instruction unit 110, a power consumption acquisition unit 120, a CPU load acquisition unit 130, a power consumption characteristic storage unit 140, a service request management unit 150, a power consumption adjustment amount calculation unit 160, and a setting command unit 170.

The power consumption instruction unit 110 receives an increase/decrease request for power consumption from the outside, and calculates the amount of power consumption to be controlled in this system.

The power consumption acquisition unit 120 acquires power consumption in units of racks. The CPU load acquisition unit 130 acquires total CPU load in units of racks.

The power consumption characteristic storage unit 140 accumulates information (power consumption characteristics) about total CPU load values and power consumption for each rack which has been acquired in advance. The service request management unit 150 manages service requests.

The power consumption adjustment amount calculation unit 160 calculates a CPU load variation amount from the amount of power consumption to be controlled, based on the power consumption characteristics.

The setting command unit 170 performs CPU load control for servers mounted on a rack based on the CPU load variation amount calculated by the power consumption adjustment amount calculation unit 160.

### Device Operation

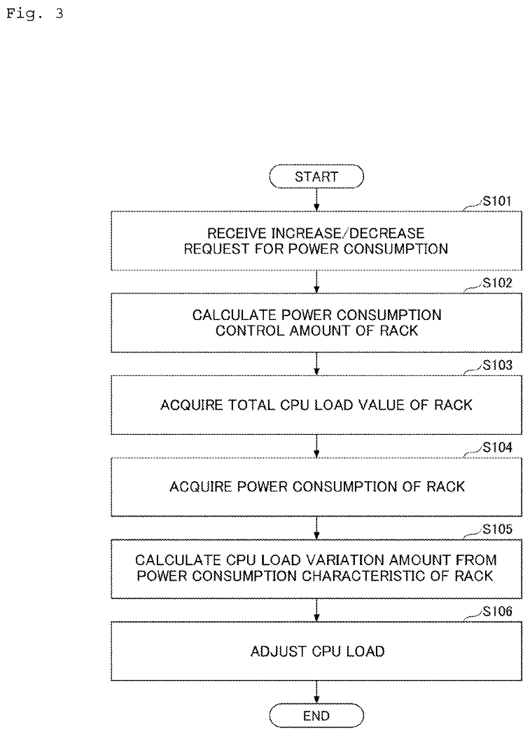

Next, a processing operation of the power control apparatus 100 will be described in accordance with procedures in the flowchart of FIG. 3.

### S101

In S101 (step 101), the power consumption instruction unit 110 receives an increase/decrease request for power consumption for this system (base 300) from an external system. The increase request includes, for example, the amount of power consumption to be increased in this system. The decrease request includes, for example, the amount of power consumption to be decreased in this system.

The external system (for example, an electric power company) makes an increase request when the amount of demand for power needs to be increased, and makes a decrease request when the amount of demand for power needs to be decreased.

### S102

In S102, the power consumption instruction unit 110 calculates the amount of power consumption control for each rack to be managed by this system, based on the increase/decrease request for the power consumption received in S101. The amount of power consumption control is information that indicates, for example, “increase the power consumption by 100 (the unit is, for example, W)” or “decrease the power consumption by 100.”

How the amount of power consumption control is allocated to each of the plurality of racks can be determined depending on a situation at the base.

For example, the amount of power consumption control may be allocated evenly across a plurality of racks. In this case, for example, when it is assumed that the request demands an increase of 1000 and there are 10 racks to be managed, it is determined to increase the power consumption by 100 per rack.

Furthermore, the amount of power consumption control may be allocated unevenly across the plurality of racks due to some factor. For example, depending on the position of a rack, an increase in the load of the rack results in a large variation in the power consumption of the base as a whole, due to an external factor (such as an air conditioner starting to operate at high speed). In this case, the power consumption instruction unit 110 allocates a small amount of power consumption control to the rack at the position (or does not control the rack) and allocates large amounts of control to the other racks.

Hereinafter, processing for one rack (referred to as a “target rack”) for which power consumption is to be controlled will be described. When there are a plurality of target racks, the following processing is performed for each target rack.

### S103

In S103, the CPU load acquisition unit 130 acquires the total CPU load value of the target rack at the present time.

### S104

In S104, the power consumption acquisition unit 120 acquires the power consumption of the target rack at the present time.

### S105

In S105, the power consumption adjustment amount calculation unit 160 calculates a CPU load variation amount required to successfully control the target rack by a power consumption control amount for the rack by using the total CPU load value at the present time, which is acquired in S103, the power consumption at the present time, which is acquired in S104, and the power consumption characteristic of the target rack, which is read out from the power consumption characteristic storage unit 140.

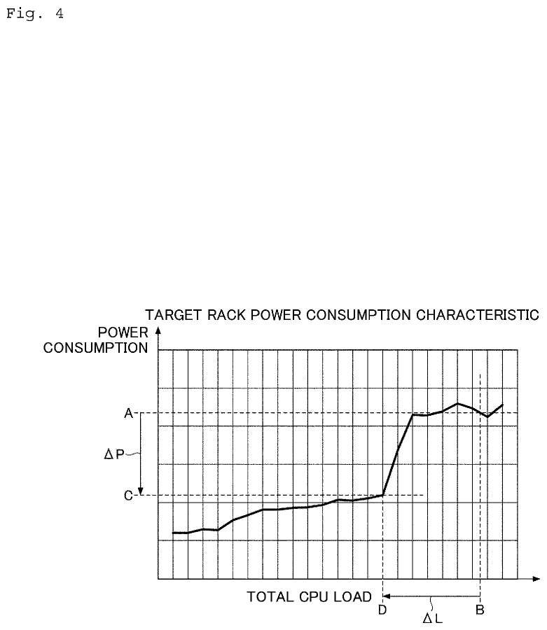

For example, it is assumed that the power consumption characteristic of the target rack is as shown in FIG. 4. At this time, it is assumed that the total CPU load value at the present time, which is acquired in S103, is a value B, and the power consumption at the present time, which is acquired in S104, is a value A. At this time, when the power consumption control amount for the target rack is “reducing power consumption by AP,” the power consumption adjustment amount calculation unit 160 acquires D as a total CPU load value corresponding to the power consumption shown as C, which is “A-ΔP.”

The power consumption adjustment amount calculation unit 160 calculates ΔL (=B−D) as a CPU load variation amount.

### S106

In S106, the setting command unit 170 changes the CPU load of each server on the target rack based on the CPU load variation amount calculated in S105.

Furthermore, as long as the total CPU load on the target rack can be changed by the CPU load variation amount calculated in S105, any method may be used to determine how much the CPU load of each server mounted on the target rack is to be changed.

For example, when there are 10 servers on the target rack and the total CPU load is to be reduced by 100, each server's CPU load may be reduced by 10. Furthermore, control may be performed such that, if there is a server among the 10 servers where the load can be reduced significantly without affecting the services (or by affecting the services only slightly), only that server's load is reduced, and no load control is applied to the rest of the servers.

Any method may be used to change the CPU load of a server. For example, when the CPU load of a server (referred to as a “target server”) is increased, a load (for example, a VM) may be moved from a server at another base to the target server. Furthermore, when the CPU load of the target server is decreased, a load may be moved from a server at another base to the target server.

Furthermore, since it is only required to change the total CPU load of all of a plurality of servers mounted on a rack by a desired amount, the accuracy of CPU load control per server may be low.

### Other Examples

In the above-described example, CPU load is used as an example of server load, but loads other than CPU load may be used as long as it is related with power consumption. For example, a memory usage rate, an interface usage rate, the temperature of a server housing, and the like may be used as server loads (or information indicating loads).

Furthermore, the power consumption characteristic may not be stored inside the power control apparatus 100. For example, the power consumption characteristic of each rack may be stored in an external database, and the power control apparatus 100 may access the database to acquire a power consumption characteristic.

In addition, control for increasing or decreasing the load of each server may be performed by a device other than the power control apparatus 100. That is, the power control apparatus 100 does not necessarily include the setting command unit 170.

Further, in the above-described example, the power control apparatus 100 calculates a CPU load variation amount based on an increase or decrease request from an external system, but this is merely an example. For example, when an administrator of a system (such as a data center) independently determines to reduce (or increase) the power consumption of the data center, the administrator may input the amount of increase (or decrease) in power consumption to the power control apparatus 100. The operation following the input is the same as the operation when an increase or decrease request is issued.

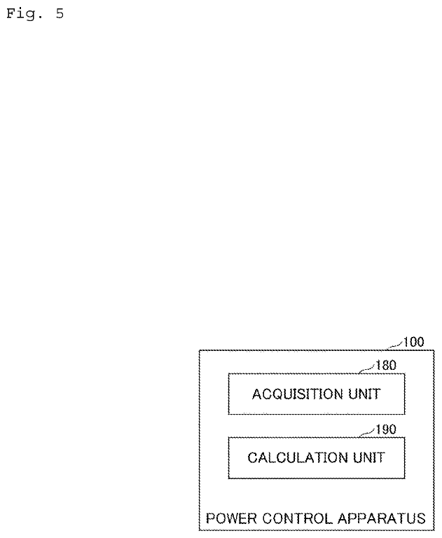

Furthermore, the power control apparatus 100 may be configured to include an acquisition unit 180 and a calculation unit 190, as shown in FIG. 5. The power consumption acquisition unit 120 and the CPU load acquisition unit 130 shown in FIG. 1 are both examples of the acquisition unit 180. In addition, the power consumption adjustment amount calculation unit 160 is an example of the calculation unit 190.

The power control apparatus 100 shown in FIG. 5 is used for a system including one or more racks each equipped with one or more servers. The acquisition unit 180 acquires power consumption and a total load value of a target rack. The calculation unit 190 calculates a load variation amount, which corresponds to the amount of power consumption control for the target rack, based on the power consumption, the total load value, and the power consumption characteristic of the target rack.

### Example of Hardware Configuration

The power control apparatus 100 described in the present embodiment can be implemented, for example, by causing a computer to execute a program. This computer may be a physical computer or a virtual machine on a cloud.

That is, the power control apparatus 100 can be implemented by executing a program corresponding to the processing performed by the power control apparatus 100 by using hardware resources such as a CPU and a memory built in a computer. The above program can be recorded on a computer-readable recording medium (such as a portable memory) and can be stored or distributed. Further, the above program can be provided through a network such as the Internet or e-mail.

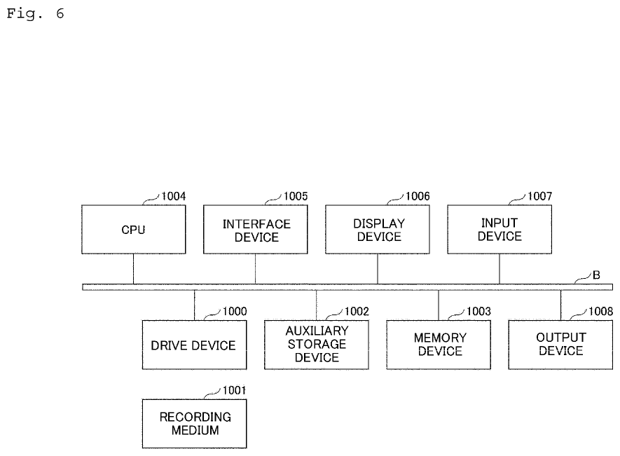

FIG. 6 is a diagram showing an example of a hardware configuration of the above computer. The computer shown in FIG. 6 includes a drive device 1000, an auxiliary storage device 1002, a memory device 1003, a CPU 1004, an interface device 1005, a display device 1006, an input device 1007, and an output device 1008, which are connected to each other via a bus BS. The computer may further include a GPU.

A program for implementing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 implements functions related to the power control apparatus 100 according to a program stored in the memory device 1003. The interface device 1005 is used as an interface for connection to a network. The display device 1006 displays a graphical user interface (GUI) or the like according to a program. The input device 1007 encompasses a keyboard, a mouse, buttons, a touch panel, or the like, and is used to input various operation instructions. The output device 1008 outputs an operation result.

### Summary, Effects, and the Like of Embodiment

As described above, the technology described in the present embodiment makes it possible to appropriately control the power consumption of a rack on which one or more servers are mounted.

Specifically, by controlling power consumption in units of racks, which has characteristics different from those of servers, it is possible to stably perform control in response to an increase/decrease request for power consumption due to external factors of a rack installation base (for example, a renewable energy power generation amount) even when the accuracy of control of CPU load is not high.

Regarding the above embodiment, the following appendices are further disclosed.

### Appendices

### Appendix 1

A power control apparatus for use in a system including one or more racks each equipped with one or more servers, the power control apparatus including:
a memory; and
at least one processor connected to the memory,
wherein the processor is configured to:
acquire power consumption and a total load value of a target rack; and
calculate a load variation amount, which corresponds to an amount of power consumption control for the target rack, based on the power consumption, the total load value, and a power consumption characteristic of the target rack.

### Appendix 2

The power control apparatus according to appendix 1, wherein the power consumption characteristic is a nonlinear characteristic that represents a relationship between the power consumption of the target rack and a total load value of one or more servers mounted on the target rack.

### Appendix 3

The power control apparatus according to appendix 1 or 2, wherein the amount of power consumption control is calculated based on an increase or decrease request received from an external system.

### Appendix 4

The power control apparatus according to any one of appendices 1 to 3, wherein the processor is configured to instruct a server mounted on the target rack to move a load based on the load variation amount.

### Appendix 5

A load variation amount calculation method to be executed by a power control apparatus for use in a system including one or more racks each equipped with one or more servers, the load variation amount calculation method including:
an acquisition step of acquiring power consumption and a total load value of a target rack; and
a calculation step of calculating a load variation amount, which corresponds to an amount of power consumption control for the target rack, based on the power consumption, the total load value, and a power consumption characteristic of the target rack.

### Appendix 6

A computer-readable non-transitory storage medium storing a program causing a computer to function as the units of the power control apparatus according to any one of appendices 1 to 4.

Although the present embodiment has been described above, the present invention is not limited to such a specific embodiment, and various modifications and changes can be made within the scope of the gist of the present invention described in the claims.

### REFERENCE SIGNS LIST

100 Power control apparatus
110 Power consumption instruction unit
120 Power consumption acquisition unit
130 CPU load acquisition unit
140 Power consumption characteristic storage unit
150 Service request management unit
160 Power consumption adjustment amount calculation unit
170 Setting command unit
180 Acquisition unit
190 Calculation unit
200 Physical network
300 Base
1000 Drive device
1001 Recording medium
1002 Auxiliary storage device
1003 Memory device
1004 CPU
1005 Interface device
1006 Display device
1007 Input device
1008 Output device

1. A power control apparatus for use in a system including one or more racks each equipped with one or more servers, the power control apparatus comprising:
a memory storing a set of instructions; and
at least one processor coupled to the memory and causing the power control apparatus, when the set of instructions in the memory are executed by the processor, to:
acquire power consumption and a total load value of a target rack; and
calculate a load variation amount, which corresponds to an amount of power consumption control for the target rack, based on the power consumption, the total load value, and a power consumption characteristic of the target rack.

2. The power control apparatus according to claim 1, wherein the power consumption characteristic is a nonlinear characteristic that represents a relationship between the power consumption of the target rack and a total load value of one or more servers mounted on the target rack.

3. The power control apparatus according to claim 1, wherein the amount of power consumption control is calculated based on an increase or decrease request received from an external system.

4. The power control apparatus according to claim 1, wherein the processor further causes the power control apparatus to instruct a server mounted on the target rack to move a load based on the load variation amount.

5. A load variation amount calculation method to be executed by a power control apparatus for use in a system including one or more racks each equipped with one or more servers, the load variation amount calculation method comprising:
acquiring power consumption and a total load value of a target rack; and
calculating a load variation amount, which corresponds to an amount of power consumption control for the target rack, based on the power consumption, the total load value, and a power consumption characteristic of the target rack.

6. A computer-readable non-transitory recording medium storing a set of instructions that, when executed by a computer, causes the computer to perform the load variation amount calculation method of claim 5.
